(19) United States
(12) Patent Application Publication
(10) Pub. No.: US 2011/0158234 A1
(43) Pub. Date: Jun. 30, 2011

(54) TELEPHONE EXCHANGE SYSTEM, TELEPHONE EXCHANGE APPARATUS, AND TELEPHONE TERMINAL

(76) Inventors: Kazuhiro Sumi, Hino-shi (JP); Yoichi Naito, Ome-shi (JP); Fumio Shibasaki, Sagamihara-shi (JP)

(21) Appl. No.: 12/968,133

(22) Filed: Dec. 14, 2010

(30) Foreign Application Priority Data
Dec. 25, 2009 (JP) JP 2009-296323

(51) Int. Cl. H04L 12/56

(52) U.S. Cl. 370/390

(57) ABSTRACT

According to one embodiment, a telephone exchange system includes a plurality of telephone terminals and a telephone exchange apparatus. The plurality of telephone terminals connected to a communication network. The telephone exchange apparatus registers the telephone terminals through the communication network, and execute multicast packet transmission of media signal including at least one of picture, voice, and data to the telephone terminals connected to the communication network. A first telephone terminal of the telephone terminals comprises a packet transfer configured to convert a received multicast packet into a unicast packet receivable by a second telephone terminal, and sends the converted unicast packet to the second telephone terminal.

### CROSS-REFERENCE TO RELATED APPLICATIONS

This application is based upon and claims the benefit of priority from Japanese Patent Application No. 2009-296323, filed Dec. 25, 2009; the entire contents of which are incorporated herein by reference.

### FIELD

Embodiments described herein relate generally to a telephone exchange system, which executes multicast transmission of media signal including at least one of picture, voice, and data to a plurality of telephone terminals connected to an Internet Protocol (IP) network, and a telephone exchange apparatus and telephone terminal used in the system.

### BACKGROUND

An IP telephone system, which realizes real-time two-way transmission and reception of audio-visual signals as packet data through Local Area Network (LAN) or Internet Protocol (IP) Network, has become widely used in recent years.

As an IP telephone system, there is a system which realizes multicast transmission of media signals such as a holding tone, a ring tone, and background music (BGM). In such a multicast system, a stream delivered by a telephone exchange apparatus is small compared with a system which makes unicast delivery for each terminal, and the same media signal can be efficiently delivered to a plurality of terminals.

In the IP telephone system, a telephone exchange apparatus includes an IP telephone terminal unable to receive a multicast packet.

As a solution to the above problem, a Voice Over Internet Protocol (VOIP) system is proposed, in which a VOIP server determines the multicast capability of each telephone terminal, and sends data in multicast to a capable terminal, and in unicast to an incapable terminal (for example, Jpn. Pat. Applin. KOKAI Publication No. 2005-6004).

In the above system, a VOIP server sends data in unicast to a multicast-incapable terminal. In this case, if many multicast-incapable IP telephone terminals are present, the communication traffic on an IP network is increased.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block schematic diagram of a first embodiment of an IP telephone system;

FIG. 2 is a diagram showing an example of contents stored in a processing capacity table shown in FIG. 1;

FIG. 3 is a diagram showing an example of contents stored in an instruction destination table shown in FIG. 1;

FIG. 4 is a block diagram showing a configuration of an IP telephone terminal shown in FIG. 1;

FIG. 5 is a flowchart of a procedure of gaining an IP address and processing capacity data of an IP telephone terminal in an IP telephone exchange apparatus of the first embodiment;

FIG. 6 shows a sequence of operations for an incoming call with a caller ID in the first embodiment;

FIG. 7 is a flowchart of control operation of a call controller of an IP telephone apparatus to be executed for the operation shown in FIG. 6;

FIG. 8 is a flowchart of control operation of an IP telephone terminal to be executed for the operation shown in FIG. 6;

FIG. 9 is a block schematic diagram of an IP telephone system according to a second embodiment;

FIG. 10 is a block diagram showing a functional configuration of a multicast-capable IP telephone terminal shown in FIG. 9;

FIG. 11 is a diagram showing an example of contents stored in a group management table shown in FIG. 10; and

FIG. 12 is a flowchart of control operation of an IP telephone terminal to transfer a unicast packet in each subnet in the second embodiment.

### DETAILED DESCRIPTION

Various embodiments will be described hereinafter with reference to the accompanying drawings, in general, according to one embodiment, a telephone exchange system includes a plurality of telephone terminals and a telephone exchange apparatus. The plurality of telephone terminals connected to a communication network. The telephone exchange apparatus registers the telephone terminals through the communication network, and executes multicast packet transmission of media signal including at least one of picture, voice, and data to the telephone terminals connected to the communication network. A first telephone terminal of the telephone terminals comprises a packet transfer configured to convert a received multicast packet into a unicast packet receivable by a second telephone terminal, and sends the converted unicast packet to the second telephone terminal, wherein the first telephone terminal is multicast-capable, wherein the second telephone terminal is multicast-incapable.

### First Embodiment

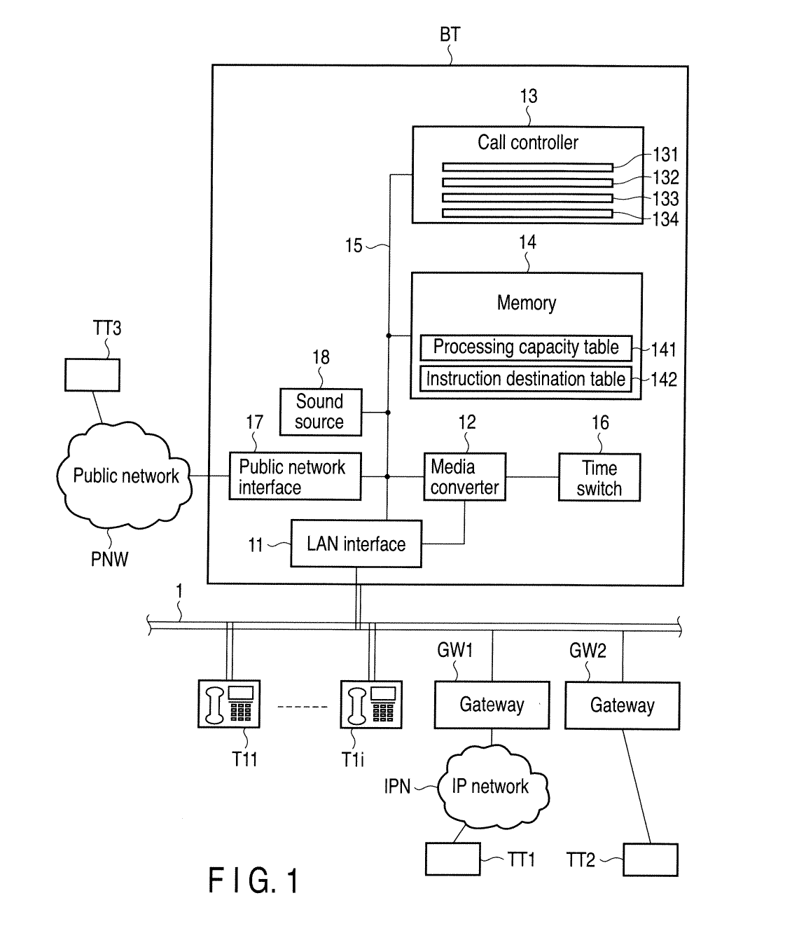

FIG. 1 is a block schematic diagram of a first embodiment of an IP telephone system. This system has a Local Area Network (LAN) 1 for packet communication. IP telephone terminals T11 to T1i (i is a natural number) are connected to the LAN 1. Each IP telephone terminal T11 to T1i has a speech processing function, and a media processing function for pictorial data.

The LAN 1 is connected to gateways GW1 and GW2. The gateway GW1 connects the LAN 1 to an IP public network IPN such as Internet, and has a function of converting a communication protocol and signal format between the LAN 1 and IP public network IPN. The gateway GW2 connects the LAN 1 to an external telephone terminal TT2, and has a function of converting a communication protocol and signal format between the LAN 1 and external telephone terminal TT2.

The IP telephone terminals T11 to T1i and gateways GW1 and GW2 are connected to an IP telephone apparatus BT as a telephone exchange apparatus through the LAN 1.

The IP telephone apparatus BT comprises a LAN interface 11, a media converter 12, a call controller 13, and a memory 14, which are connected to one another through a data highway 15. A public network interface 17 and a sound source 18 are connected to the data highway 15.

The LAN 1 is connected to the LAN interface 11 if necessary. The LAN interface 11 performs interface operation with the connected LAN 1. The LAN interface 11 swaps various control information related to the interface operation, with the call controller 13 through the data highway 15.

A time switch 16 is connected to the media converter 12. The media converter 12 is configured to process a control packet and a voice packet received by the LAN interface 11. The media converter 12 converts a packet into a PCM signal and sends it to the time switch 16, and converts a PCM signal from the time switch 16 into a packet and sends it to the LAN interface 11.

A public network PNW is connected to the public network interface 17 if necessary. The public network interface 17 performs interface operation with the connected public network PNW. The public network interface 17 swaps various control information related to the interface operation, with the call controller 13 through the data highway 15.

The call controller 13 comprises a CPU, a ROM, and a RAM, and controls each part of the IP telephone apparatus BT by software processing.

The memory 14 stores routing data necessary for connection control of the call controller 13.

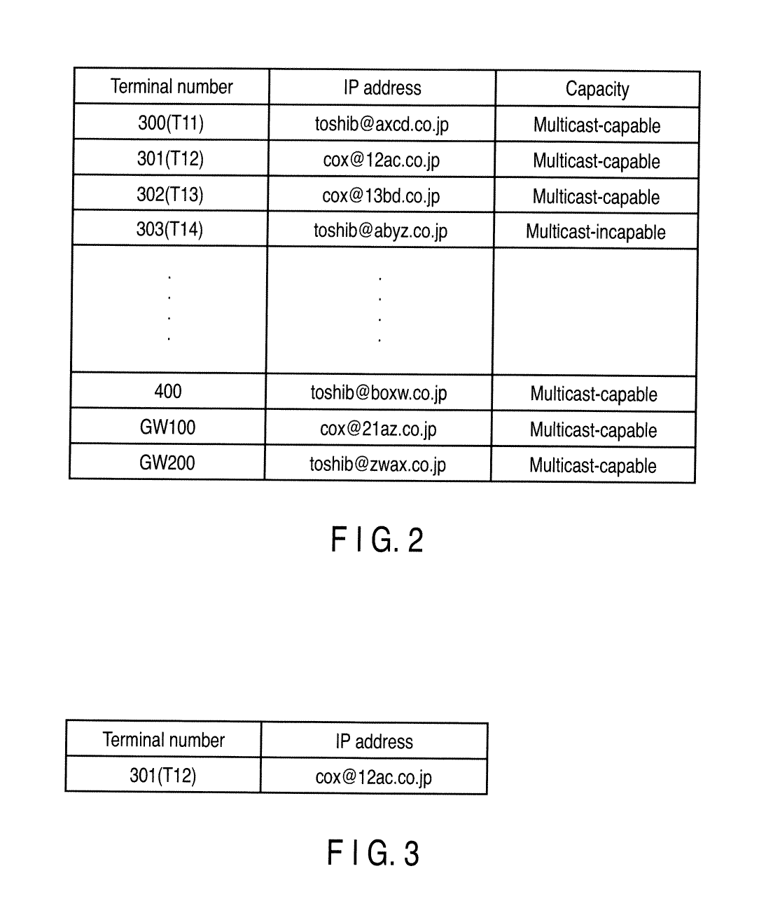

The memory 14 stores a processing capacity table 141, and an instruction destination table 142. The processing capacity table 141 associates terminal numbers as terminal IDs previously assigned to IP telephone terminals T11 to T1i and gateways GW1 and GW2, IP addresses of the terminals and gateways, and their multicast capability information, as shown in FIG. 2.

The instruction destination table 142 associates the terminal number and IP address of the IP telephone terminal T12 as a first telephone terminal, which requests packet conversion and transfer of an unicast packet, as shown in FIG. 3.

The call controller 13 comprises a capacity inquirer 131, a registration controller 132, a capacity determination module 133, and a transfer instruction controller 134. The capacitor inquirer 131 sends the activated IP terminal T11 to T1i information to inquire about the multicast capability by inserting into a SIP OPTION message, for example, to the IP terminals T11 to T1i and gateways GW1 and GW2. As for the gateways GW1 and GW2, the capacity data shall be previously registered in the processing capacity table 141.

The registration controller 132 gains the capacity data included in SDP in ACK responded to the inquiry, associates the capacity data with the terminal number of the responding terminal, and register it in the processing capacity table 141.

When a multicast packet is received, the capacity determination module 133 consults the processing capacity table 141, and determines whether a multicast-capable terminal is present.

When a multicast-incapable IP telephone terminal T14 is present, the transfer instruction controller 134 sends the IP telephone terminal T12 registered in the instruction destination table 142 an instruction to convert a multicast packet into an unicast packet and transfer it to the multicast-incapable IP telephone terminal T14, based on the result of consultation by the capacity determination module 133.

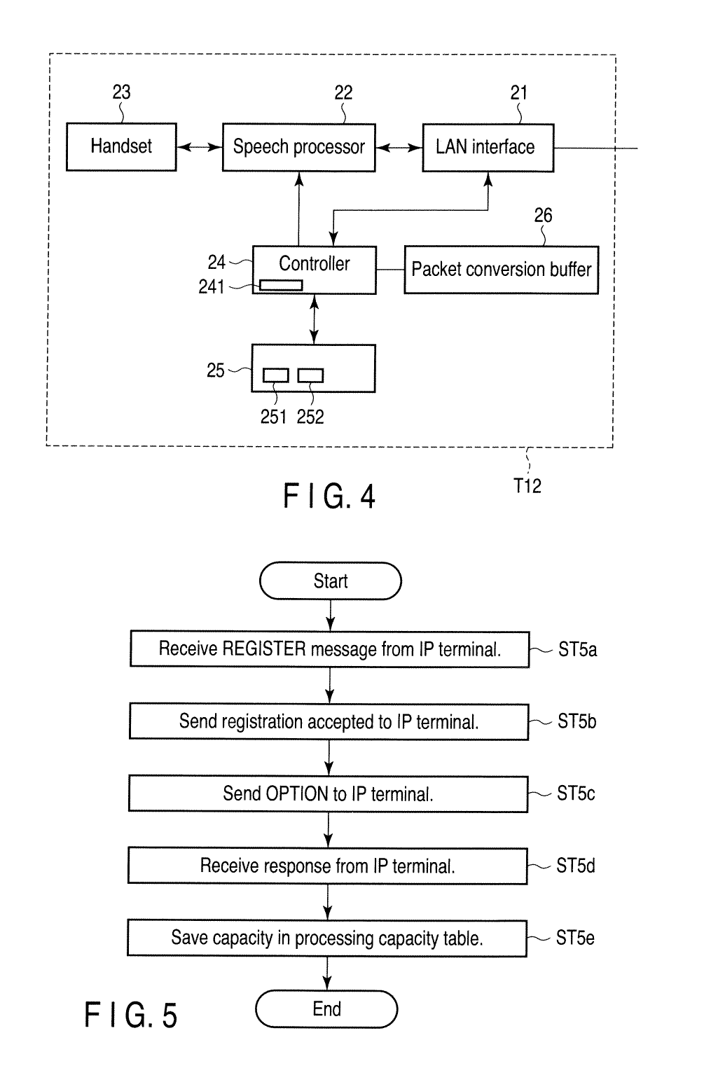

FIG. 4 is a block diagram showing the configuration of the IP telephone terminal T12.

In FIG. 4, the IP telephone terminal T12 comprises a LAN interface 21, a speech processor 22, a handset 23, a controller 24, and an operation panel 25. A packet conversion buffer 26 is connected to the controller 24.

The LAN interface 21 swaps various data with an external apparatus. The LAN interface 21 extracts a speech signal and control signal included in a transmission signal sent from an external device, and sends a speech signal to the speech processor 22, and a control signal to the controller 24, respectively. The LAN interface 21 generates a transmission signal by time-division multiplexing a serial data signal sent from the speech processor 22 and controller 24, and transmits the obtained signal.

The speech processor 22 takes out speech data included in a speech signal sent from the LAN interface 21, and reproduces a received analog voice signal from the speech data. The speech processor 22 drives a receiver of the handset 23 by the reproduced received voice signal, and outputs the received voice. The speech processor 22 receives a spoken analog voice signal generated by a transmitter of the handset 23. The speech processor 22 converts the spoken voice signal into a speech signal of predetermined form, and sends it to the LAN interface 21.

The controller 24 comprises a CPU, a ROM, and a RAM, and controls each part of the IP telephone terminal T12, and performs data communication with an external device by software processing.

The operation panel 25 comprises a display 251 such as a Liquid Crystal Display (LCD), and a key input module 252. The display 251 displays various data indicating the states of the apparatus output from the controller 24, and a media signal in multicast transmission, for example, a telephone directory.

The controller 24 includes a packet conversion transfer module 241. When a transfer instruction is received from the IP telephone apparatus BT, while receiving a multicast packet, the packet conversion transfer module 241 saves a multicast packet in the packet conversion buffer 26, converts a multicast packet into a unicast packet, and sends it to the destination IP telephone terminal T14 included in the transfer instruction.

Next, operations to be executed in the above configuration will be explained.

FIG. 5 is a flowchart of a procedure of gaining IP addresses and processing capacity data of IP telephone terminals T11 to T1i, in an IP telephone exchange apparatus BT. In case of SIP, a REGISTER message is sent from each IP telephone terminal T11 to T1i to the IP telephone apparatus BT at a predetermined cycle at the time of startup. The IP telephone apparatus BT receives the REGISTER message, and registers each IP address in the processing capacity table 141 in the memory 14. When the IP telephone terminal T14, for example, does not send a REGISTER message at a predetermined cycle, the IP telephone apparatus BT determines that the IP telephone terminal T14 is not present, and the IP telephone terminal T14 is disabled to make communication.

When the IP telephone apparatus BT receives a REGISTER message from the IP telephone terminal T11, for example, (block ST5a), the IP telephone apparatus BT registers the IP address in the processing capacity table 141, and if the registration is accepted, the IP telephone apparatus BT returns ACK to the IP telephone terminal T11 (block ST5b).

Further, the IP telephone apparatus BT sends OPTIONS to the IP telephone terminal T11 to inquire its capacity (block ST5c). The IP telephone apparatus BT receives a response to the OPTIONS (block ST5d), takes out the capacity data about the multicast capability included in SDP, and registers it in the processing capacity table 141 (block ST5e).

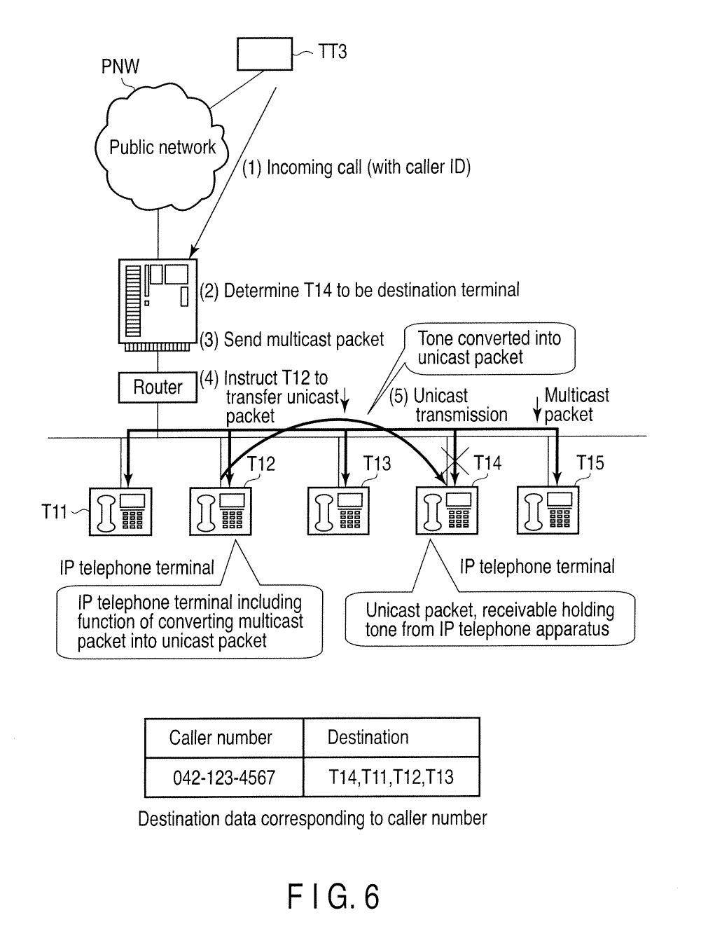

FIG. 6 shows a sequence of operations for an incoming call with a caller ID.

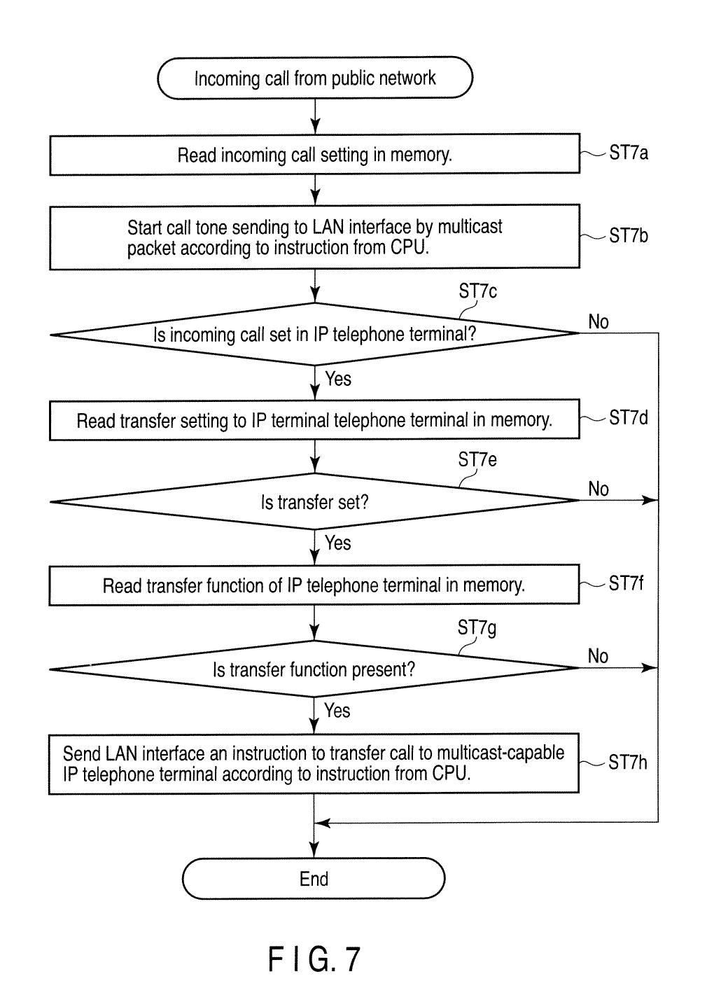

It is assumed that the public network interface 17 receives an incoming call signal with a caller ID from the public network PNW in response to a call originated by the external telephone terminal TT3. In this case, the call controller 13 of the IP telephone apparatus BT executes the control operation shown in FIG. 7.

The call controller 13 of the IP telephone apparatus BT extracts a caller ID from the incoming call data sent from the pubic network interface 17, and determines a destination corresponding to the caller ID based on the incoming call data stored in the memory 14 (block ST7a). The call controller 13 transfers a ring tone generated by the sound source 18 to the LAN interface 11, and notifies the incoming call by sending the incoming call data to the IP telephone terminals T11 to T1i, that is, an extension group for an incoming call (block ST7b).

The call controller 13 of the IP telephone apparatus BT consults the processing capacity table 141, and determines whether a multicast-incapable IP telephone terminal is present in the destination (block ST7c). As the multicast-capable IP telephone terminal T14 is present in the extension group in the destination, the call controller 13 of the IP telephone apparatus BT consults the instruction destination table 142 (block ST7d), and determines whether the IP telephone terminal T12 is included in the extension group of the destination (block ST7e).

Since the IP telephone terminal T12 is included in the extension group, the call controller 13 of the IP telephone apparatus BT sends the IP telephone terminal T12 an instruction to transfer the call to the IP telephone terminal T14 (blocks ST7g and ST7h).

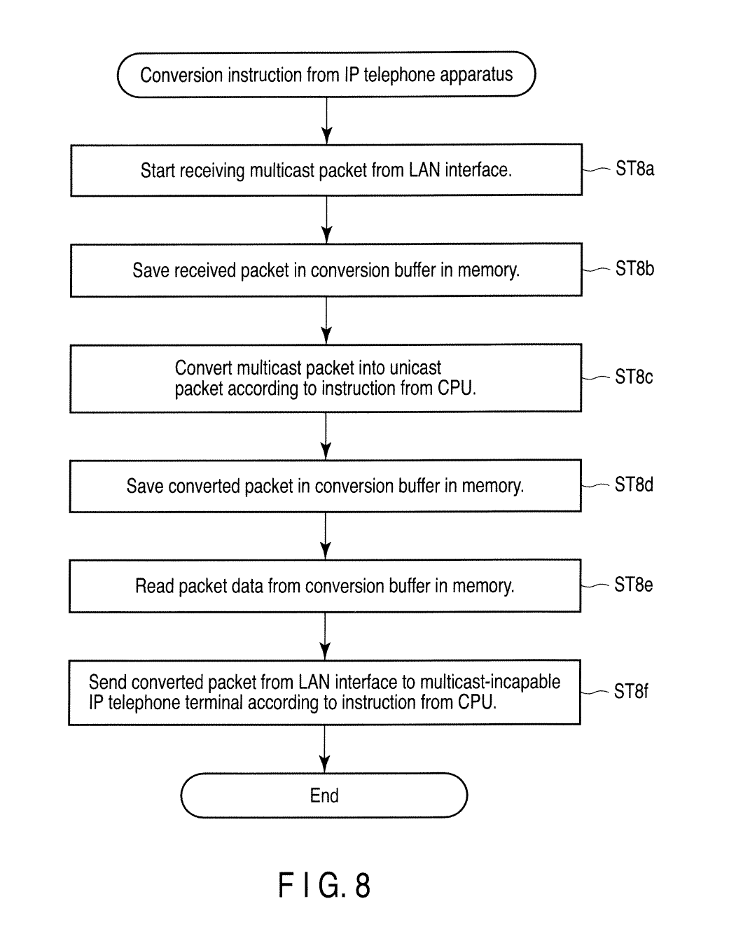

The IP telephone terminal T12 executes the control operation shown in FIG. 8.

The IP telephone terminal T12 receives a multicast packet from the IP telephone apparatus BT (block ST8a), saves the received multicast packet in the packet conversion buffer 26 (block ST8b), converts the multicast packet into a unicast packet (block ST8c), and saves the converted unicast packet in the packet conversion buffer 26 (block ST8d).

The IP telephone terminal T12 recognizes the destination IP telephone terminal T14 included in the transfer instruction, and reads the unicast packet from the packet conversion buffer 26 (block ST8e), and sends the unicast packet to the IP telephone terminal T14 (block ST8f).

Therefore, an incoming call from the public network PNW is notified the IP telephone terminal T14. In block ST7e, if the multicast-incapable IP telephone terminal T14 is not a destination, or if the multicast-capable IP telephone terminal T12 is not registered in the instruction destination table 142, the IP telephone apparatus BT terminates the operation, and continues sending a call tone as a multicast packet.

As described above, in the first embodiment, the multicast-capable IP telephone terminal T12 is given the function of converting a multicast packet into a unicast packet, and transferring it to the multicast-incapable IP telephone terminal T14. In the IP telephone apparatus BT, the memory 14 stores the processing capacity table 141, which associates the terminal numbers and IP addresses of IP telephone terminals T11 to T1i with their media processing capacity data. When a multicast packet is executed, the processing capacity table 141 is consulted, and the IP telephone terminal T12 registered in the instruction destination table 142 is instructed to convert a multicast packet into a unicast packet, and transfer it to the IP telephone terminal T14.

Therefore, as the IP telephone apparatus BT needs not to send a unicast packet, the number of packets sent from the IP telephone apparatus BT can be decreased. The multicast-incapable IP telephone terminal T14 on the LAN 1 needs not be changed to a multicast-capable terminal, and the system cost can be reduced.

Further, in the first embodiment, the call controller 13 of the IP telephone apparatus BT is provided with the capacity inquirer 131 which inquires the IP addresses and media processing capacity of the IP telephone terminals T11 to T1i, and the registration controller 132 which registers the IP addresses and media processing capacity data responded to the inquiry in the processing capacity table 141. Therefore, it is possible to inquire the media processing capacity of each activated IP telephone terminal T11 to T1i, and register the responded media processing capacity in the processing capacity table 141.

### Second Embodiment

In a second embodiment, a multicast-capable IP telephone terminal is given the function of transferring a unicast to a multicast-incapable IP telephone terminal without an instruction from an IP telephone apparatus. A plurality of IP telephone terminals is divided into subnets.

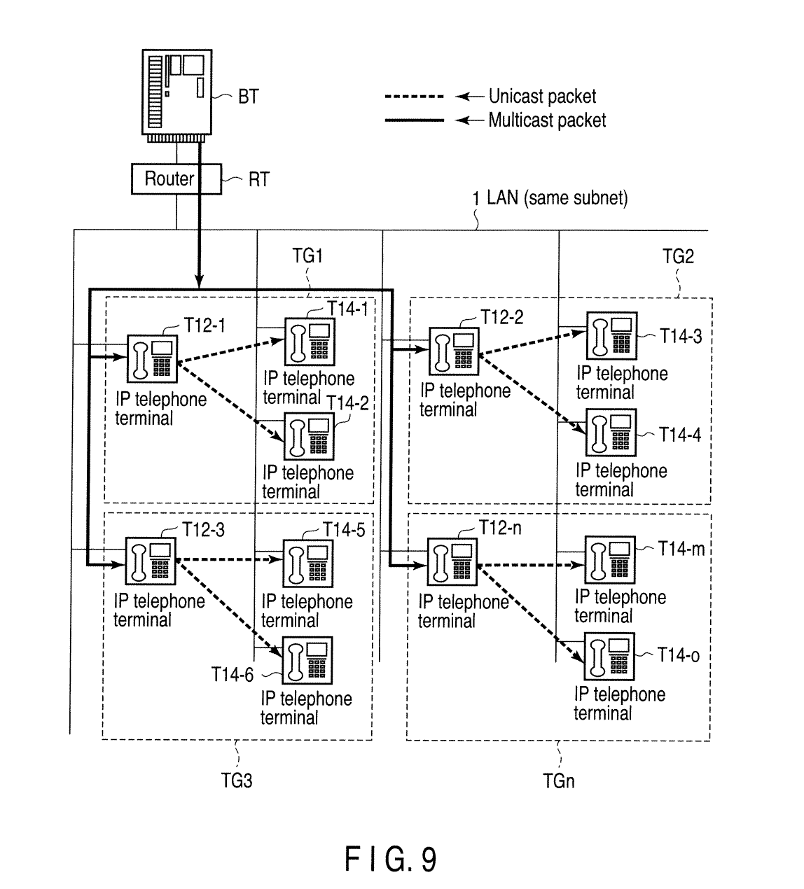

FIG. 9 is a block schematic diagram of an IP telephone system according to a second embodiment.

In this IP telephone system, multicast-capable IP telephone terminals T12-1 to T12-n are connected to a LAN 1, and multicast-incapable IP telephone terminals T14-1 to T14-o are connected to the IP telephone terminals T12-1 to T12-n.

These multicast-capable IP telephone terminals T12-1 to T12-n and multicast-incapable IP telephone terminals T14-1 to T14-o are divided into subnets TG1 to TGn.

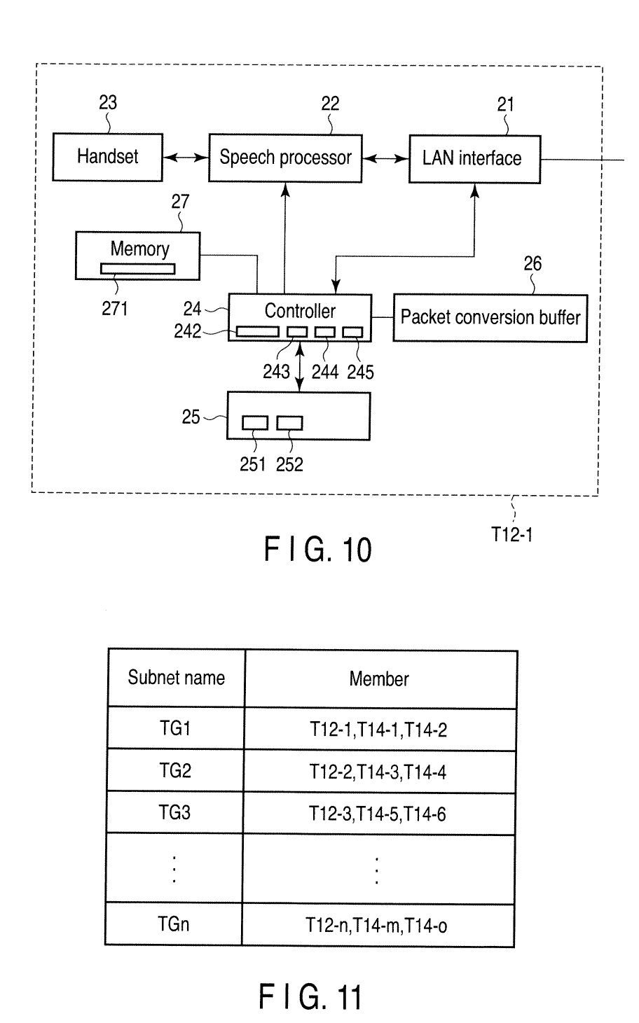

FIG. 10 is a block diagram showing a functional configuration of multicast-capable IP telephone terminals. In FIG. 10, the same reference numbers are given to the same parts in FIG. 4, and detailed explanation thereof are omitted. The IP telephone terminal T12-1 is explained as a representative.

The IP telephone terminal T12-1 is provided with a memory 27. The memory 27 stores a group management table 271. The group management table 271 associates subnets TG1 to TGn with addresses and capacity data of multicast-capable IP telephone terminals T12-1 to T12-n and multicast-incapable IP telephone terminals T14-1 to T14-o belonging to these subnets TG1 to TGn, as shown in FIG. 11.

A controller 24 comprises a capacity inquirer 242, a registration controller 243, a capacity determination module 244, and a transfer controller 245. The capacitor inquirer 242 sends the activated IP telephone terminal T12-1 to T12-n and T14-1 to T14-o information to inquire about the multicast capability by inserting into a SIP OPTION message, for example.

The registration controller 243 gains capacity data included in SDP in ACK responded to the inquiry, associates the capacity data with the terminal number of the responding terminal, and register it in the group management table 271.

When a multicast packet is received from the IP telephone apparatus BT, the capacity determination module 244 consults the group management table 271, and determines whether a multicast-incapable terminal is present.

The transfer controller 245 converts an unicast packet into a multicast packet, and sends the converted unicast packet to multicast-incapable IP telephone terminals T14-1 and T14-2, when the multicast-incapable IP telephone terminals T14-1 and T14-2 belong to the subnet TG1, based on the result of determination by the capacity determination module 244.

Next, operations with the above configuration are explained.

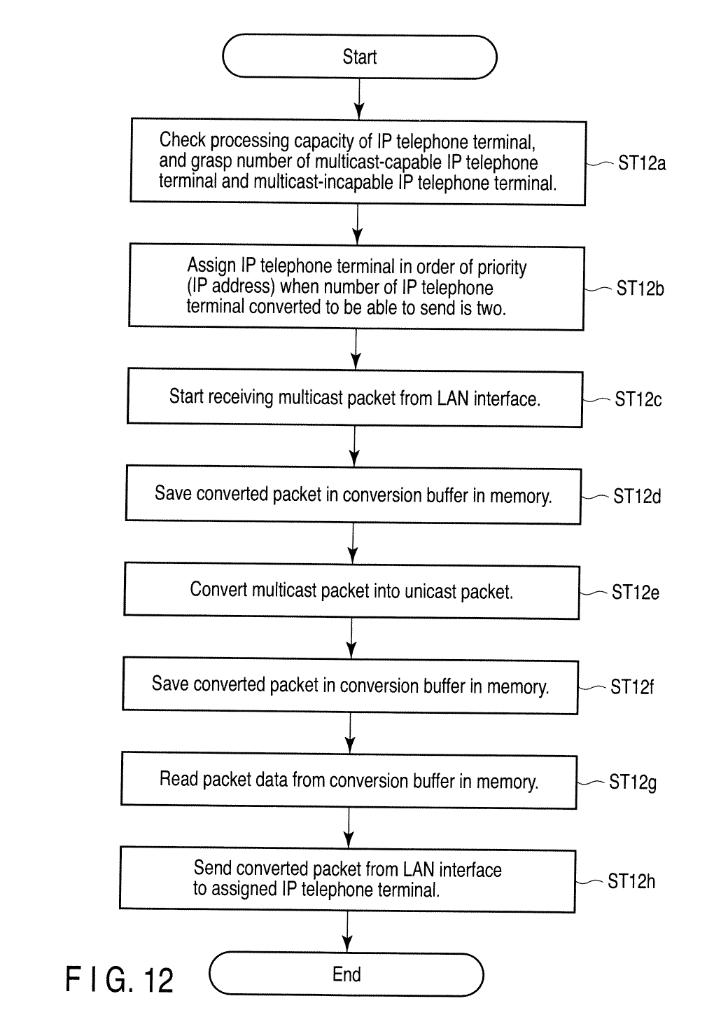

FIG. 12 is a flowchart of control operation of the IP telephone terminal T12-1 to transfer a unicast packet in each subnet TG1 to TGn.

The IP telephone terminal T12-1 inquires the IP telephone terminals T12-2 to T12-n and T14-1 to T14-o about the multicast capability, grasps the number of multicast-capable terminals and non-capable terminals (block ST12a), assigns multicast-incapable IP telephone terminals T14-1 to T14-o to the multicast-capable IP telephone terminals T12-1 to T12-n, respectively, and creates the group management table 271 (block ST12b).

The IP telephone terminal T12-1 receives a multicast packet from the IP telephone apparatus BT (block ST12c), saves the received multicast packet in the packet conversion buffer 26 (block ST12d), converts the multicast packet into a unicast packet (block ST12e), and saves the converted unicast packet in the packet conversion buffer 26 (block ST12f).

The IP telephone terminal T12-1 consults the group management table 271, recognizes the belonging subnet TG1, reads the unicast packet from the packet conversion buffer 26 (block ST12g), and sends the unicast packet to the IP telephone terminals T14-1 and T14-2 (block ST12h).

As described above, in the second embodiment, the multicast-capable IP telephone terminal T12-1 is provided with the memory 27 storing the group management table 271 which associates the subnets TG1 to TGn with the IP addresses and processing capacity of IP telephone terminals. When a multicast packet is received from the IP telephone apparatus BT, the IP telephone terminal T12-1 consults the group management table 271, converts the multicast packet into a unicast packet, and transfers it to the multicast-incapable telephone terminals T14-1 and T14-2 in the subnet TG1 to which the terminal T12-1 belongs, without an instruction from the IP telephone apparatus BT.

Therefore, the IP telephone apparatus BT may transmit a multicast packet only to the LAN 1, and the processing load of the IP telephone apparatus BT is reduced.

Further, according to the second embodiment, a multicast packet is converted into a unicast packet within the subnet TG1, and a converted unicast packet is transferred to the multicast-incapable IP telephone terminals T14-1 and T14-2. This prevents a traffic increase in the LAN 1 caused by an increase in the system scale.

### Other Embodiments

The embodiments are not limited to those described herein. For example, in the second embodiment, a group management table is stored in a memory of a multicast-capable IP telephone terminal. However, a group management table is not limited to this place. It may be stored in a memory of an IP telephone apparatus. This can decrease the memory capacity of an IP telephone terminal, and reduce the cost of an IP telephone terminal.

In each of the embodiments described herein, SIP is used to the processing capacity of each IP telephone terminal. This is applicable to MEGACO, for example.

Further, a configuration of an IP telephone system, a functional configuration of an IP telephone apparatus, a functional configuration of an IP telephone terminal, kinds of multicast and unicast, and

procedure and contents of each control may be embodied in other specific forms without departing from the spirit and essential characteristics.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form the embodiments described herein may be made without departing from the spirit of the inventions. The accompanying claims and their equivalents are intended to cover such forms or modifications as would fall within the scope and spirit of the inventions.

What is claimed is:

1. A telephone exchange system comprising:
a plurality of telephone terminals connected to a communication network; and
a telephone exchange apparatus configured to register the telephone terminals through the communication network, and execute multicast packet transmission of media signal including at least one of picture, voice, and data to the telephone terminals connected to the communication network,
a first telephone terminal of the telephone terminals comprises a packet transfer configured to convert a received multicast packet into a unicast packet receivable by a second telephone terminal, and sends the converted unicast packet to the second telephone terminal, wherein the first telephone terminal is multicast-capable, wherein the second telephone terminal is multicast-incapable.

2. A telephone exchange apparatus registering a
plurality of telephone terminals through a communication network, and executing multicast packet transmission of media signal including at least one of picture, voice, and data to the telephone terminals connected to the communication network, the telephone exchange apparatus comprising:
a memory configured to store a management table indicating a correspondence relation between a terminal ID to identify the telephone terminal, and a media processing capacity of the telephone terminal; and
a controller configured to refer the management table at the execution of multicast transmission, and send a first telephone terminal of the telephone terminals an instruction to convert a multicast packet into a unicast packet, and to transfer the converted unicast packet to a second multicast-incapable telephone terminal, based on a reference result of the management table, wherein the first telephone terminal is multicast-capable, wherein the second telephone terminal is multicast-incapable.

3. The telephone exchange apparatus of claim 2, further comprising:
an inquirer configured to inquire the telephone terminals about the terminal ID and media processing capacity; and
a registration controller configured to register data indicating the terminal ID and media processing capacity responded to the inquiry, in the management table.

4. The telephone exchange apparatus of claim 3, wherein the inquirer sends the telephone terminal a message to inquire the media processing capacity, when the telephone terminal is activated.

5. The telephone exchange apparatus of claim 2, wherein the memory stores a group management table indicating a correspondence relation between a plurality of groups obtained by dividing the plurality of telephone terminals, and a terminal ID to identify the telephone terminal, and a media processing capacity of the telephone terminal, and
the controller refers the group management table at the execution of multicast packet transmission, and sends the first telephone terminal in each group an instruction to convert a multicast packet into a unicast packet, and to transfer the converted unicast packet to the second telephone terminal, based on the reference result of the group management table.

6. A telephone terminal which is registered in a telephone exchange apparatus through a communication network, and configured to receive a media signal including at least one of picture, voice and data sent by multicast packet transmission to a plurality of telephone terminals connected to the communication network, the telephone terminal comprising:
a memory configured to store a management table indicating a correspondence relation between a terminal ID to identify the telephone terminal, and a media processing capacity of the telephone terminal; and
a packet transfer configured to refer the management table, when receiving a media signal by the multicast packet transmission from the telephone exchange apparatus, converts the received multicast packet into a unicast packet, and sends the converted unicast packet to a telephone terminal unable to receive a media signal sent by the multicast transmission, based on a reference result of the management table.

7. The telephone terminal of claim 6, further comprising:
an inquirer configured to inquire the telephone terminals about the terminal ID and media processing capacity; and
a registration controller configured to register data indicating the terminal ID and media processing capacity responded to the inquiry, in the management table.

8. The telephone terminal of claim 7, wherein the inquirer sends the telephone terminal a message to inquire the media processing capacity, when the telephone terminal is activated.

9. The telephone terminal of claim 6, wherein the memory stores a group management table which associates a plurality of groups obtained by dividing the plurality of telephone terminals, with a terminal ID to identify the telephone terminal, and a media processing capacity of the telephone terminal, and
the packet transfer refers the group management table at the execution of multicast packet transmission, and converts a received multicast packet into a unicast packet, and sends the converted unicast packet to a telephone terminal unable to receive a media signal sent by the multicast delivery, in a group to which the terminal belongs, based on a reference result of the group management table.
